(19) United States
(12) Patent Application Publication
(10) Pub. No.: US 2019/0249406 A1
(43) Pub. Date: Aug. 15, 2019

(54) REMOTE STORMWATER MANAGEMENT POND VOLUME ADJUSTMENT SYSTEM

(71) Applicant: Environmental Quality Resources, Inc., Edgewater, MD (US)

(72) Inventor: Carter B. McCamy, Edgewater, MD (US)

(21) Appl. No.: 16/275,484

(22) Filed: Feb. 14, 2019

Related U.S. Application Data
(60) Provisional application No. 62/630,958, filed on Feb. 15, 2018.

(51) Int. Cl. E03F 5/10; E03F 1/00; G05D 7/06

(52) U.S. Cl. CPC E03F 5/107; E03F 5/103; G06F 9/542; G05D 7/0676; G05D 7/0623; E03F 1/00

(57) ABSTRACT

A remote pond volume adjustment system includes a control circuit, a weather receiver configured to receive a public broadcast from the National Weather Service, and a weather receiver decoder connected with the weather receiver and the control circuit that is configured to digitize the public broadcast and output a digital weather code. A cellular network communication device connected with the control circuit is configured to communicate with a property manager/owner. The control circuit is programmed to selectively open and close a drain valve based on at least one of a communication from the property manager and the digital weather code.

### CROSS-REFERENCES TO RELATED APPLICATIONS

This application claims the benefit of U.S. Provisional Patent Application No. 62/630,958, filed Feb. 15, 2018, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to remote stormwater management and, more particularly, a remote operated system that will allow individuals, companies, government agencies, etc. to adjust the level of a stormwater pond (ponds, lakes canals, and other such stormwater storage facilities, impoundments) in anticipation of a flood threat. The system allows for additional quantity storage, which helps reduce downstream and low area flooding.

Effective management of stormwater is one of the largest engineering problems faced by the Federal government, state governments, cities and local jurisdictions today. Because of rapid urbanization, aging infrastructure, and a changing climate, these challenges are expected to intensify in the decades to come. Floods are the leading cause of severe weather fatalities worldwide, accounting for roughly 540,000 deaths between 1980 and 2009.

Hurricane Harvey was a Category 4 storm that hit Texas on Aug. 25, 2017. It caused $125 billion in damage according to the National Hurricane Center. Harvey made landfall three times in six days. At its peak on Sep. 1, 2017, one-third of Houston was underwater. Two feet of rain fell in the first 24 hours. Flooding forced 39,000 people out of their homes and into shelters. In the Gulf area, 1 million vehicles were ruined beyond repair, according to auto data firm Black Book. That includes 300,000 to 500,000 vehicles owned by individuals.

Conventional stormwater management utilizes engineered facilities, including ponds and storage basins to retain stormwater for anticipated rainfall impacts. Many thousand such storm water retention systems are in place throughout the U.S. Engineered stormwater facilities are designed to store and release stormwater to minimize impacts to man-made and environmental features within the downstream watershed. Water release is controlled by valves to discharge pipes, overflow pipes, overflow weirs and other such designed control systems.

The designed release rate for stormwater facilities is based on historical rainfall data. Heavy downpours are increasing nationally, especially over the last three to five decades. The heaviest rainfall events have become heavier and more frequent, and the amount of rain falling on the heaviest rain days has also increased. Since 1991, the amount of rain falling in very heavy precipitation events has been significantly above average. This increase has been greatest in the Northeast, Midwest, and upper Great Plains—more than 30% above the 1901-1960 average. There has also been an increase in flooding events in the Midwest and Northeast, where the largest increases in heavy rain amounts have occurred.

### BRIEF SUMMARY

The system of the described embodiments utilizes a proprietary design to allow the owner/manager of a stormwater facility to release existing stored water prior to an anticipated heavy rain event. This premeditated release of stored water will allow a larger storage volume within the stormwater facility, providing a higher level of protection for downstream environmental features, property and man-made structures. This system can be adapted to existing facilities or incorporated in the initial design of new stormwater facilities.

Unlike prior systems, this system is capable of responding automatically to the NOAA Weather Radio All Hazards (NWR) nationwide network of radio stations broadcasting continuous weather information from the nearest National Weather Service office. The system receives and reacts to the weather hazard warning and can automatically open a stormwater valve, sluice gate or other control mechanism, to lower existing water levels, providing additional stormwater storage. The system can be adapted to react in the same manner to cellular communications from the owner/manager, or from Wireless Emergency Alerts (WEAs), made available through the Integrated Public Alert and Warning System (IPAWS) infrastructure managed by Federal or local government agencies.

The system can also be controlled, by way of cellular communication, by the owner/manager. Cellular communication between the system and the owner/manager can be received and managed via an internet or cloud-based platform. This platform would allow the owner/manager to manage the system and know the status of the control mechanism.

The system allows the owner to read battery voltage, NOAA Weather receiver signal strength and valve status. The system allows the owner to change NOAA Weather receiver channel for each remote system.

In an exemplary embodiment, a remote pond volume adjustment system includes a control circuit, a weather receiver configured to receive a public broadcast from the National Weather Service, and a weather receiver decoder connected with the weather receiver and the control circuit that is configured to digitize the public broadcast and output a digital weather code. A cellular network communication device connected with the control circuit is configured to communicate with a property manager. The control circuit is programmed to selectively open and close a drain valve based on at least one of a communication from the property manager and the digital weather code.

In another exemplary embodiment, a method of remotely adjusting pond volume includes the steps of (a) receiving with a weather receiver a public broadcast from the National Weather Service; (b) digitizing with a weather receiver decoder the public broadcast and outputting a digital weather code; (c) providing a cellular network communication device configured to communicate with a property manager; and (d) selectively opening and closing a drain valve based on at least one of a communication from the property manager and the digital weather code.

In yet another exemplary embodiment, a remote pond volume adjustment system is provided for adjusting a water volume in a pond, where the pond includes a primary drain valve connected to an overflow reservoir. The remote pond volume adjustment system includes a housing positioned in a vicinity of the pond, a circuit board mounted in the housing and defining a control circuit, a weather receiver mounted in the housing and configured to receive a public broadcast from the National Weather Service, and a weather receiver decoder mounted in the housing and connected with the weather receiver and the control circuit. The weather receiver decoder is configured to digitize the public broadcast and output a digital weather code. A cellular network communication device is at least partially mounted in the housing and connected with the control circuit. The cellular network communication device is configured to communicate with a property manager. A storm drain valve is connected to the overflow reservoir, and a drain valve actuator connected with the storm drain valve and the control circuit is configured to drive the storm drain valve between a closed position and an open position. The control circuit is programmed to selectively open and close the storm drain valve by activating the drain valve actuator based on at least one of a communication from the property manager and the digital weather code.

### BRIEF DESCRIPTION OF THE DRAWINGS

These and other aspects and advantages will be described in detail with reference to the accompanying drawings, in which:

FIG. 1 shows an exemplary configuration of the remote pond volume adjustment system according to the described embodiments;

FIGS. 2A and 2B are illustrative drawings showing an application of the remote pond volume adjustment system; and

FIG. 3 is a schematic illustration of a suitable control circuit for the remote pond volume adjustment system.

### DETAILED DESCRIPTION

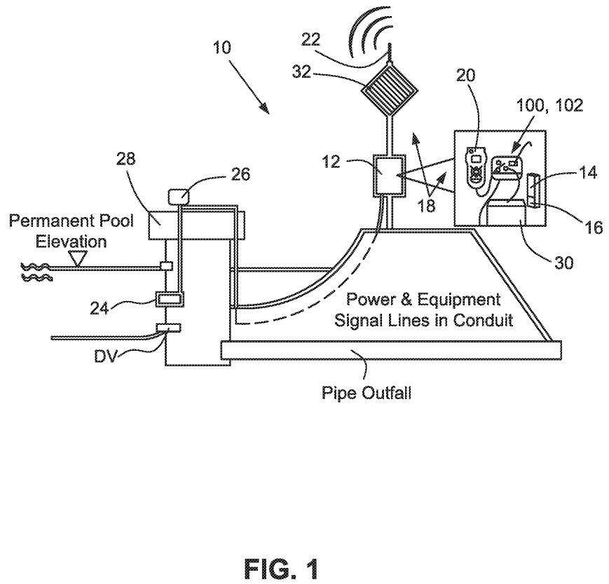

FIG. 1 shows an exemplary remote pond volume adjustment system 10 for adjusting a water volume in a pond. As shown, the pond may include a primary drain valve DV connected via a pipe or the like to an overflow reservoir OR. The drain valve DV is used to drain the pond if needed for maintenance, construction, or other access to the pond bed. The pond may also include an overflow drain to maintain a certain water level.

The remote pond volume adjustment system 10 includes a housing 12 positioned in a vicinity of the pond. For this application, a “vicinity” could be adjacent the pond edge or up to 100-200 feet from the pond edge. In a preferred construction, the drain valve actuator (discussed in more detail below) is connected to the circuit board/control circuit with a wired connection, and there may be limitations with regard to how far the housing 12 is positioned from the pond.

A computer system 100 including a computing device 102 in the form of a circuit board is mounted in the housing 12 and defines a control circuit. A weather receiver 14 is mounted in the housing 12 and is configured to receive a public broadcast from the National Weather Service. The National Weather Service broadcasts official service warnings, watches, forecasts and other hazard information 24 hours a day, seven days a week. Broadcasts are found in the VHF public service band at various predefined frequencies. The weather receiver 14 is specifically configured to receive the National Weather Service broadcast.

A weather receiver decoder 16 is mounted in the housing 12 and is connected with the weather receiver 14 and the control circuit 102. The weather receiver decoder 16 is known, and details thereof will not be further described. The weather receiver decoder 16 is configured to digitize the public broadcast and output a digital weather code. There are numerous weather codes associated with a particular weather condition or forecast. The codes are established by the National Oceanic and Atmospheric Administration (NOAA), which is part of the Department of Commerce.

A cellular network communication device 18 is connected with the control circuit 102. The cellular network communication device may include a cellular modem 20, such as a quad band cellular modem, mounted in the housing 12 and a cellular antenna 22. The cellular network communication device 18 is configured to communicate with the owner/property manager associated with the pond.

A storm drain valve 24 connects the pond to the overflow reservoir OR. Use of the term “drain valve” is meant to encompass any structure suitable for reducing the volume of water in the pond or delivering water from the pond to an overflow reservoir. For example, the drain valve may be in the form of a sluice gate or the like. As shown, the storm drain valve 24 may be positioned vertically higher in the pond than the primary drain valve DV. A drain valve actuator/motor 26 is mounted on a pond fixture 28 and is connected with the storm drain valve 24 and the control circuit 102. The drain valve actuator/motor 26 is configured to drive the storm drain valve 24 between a closed position and an open position. In some embodiments, the connection between the drain valve actuator/motor 26 and the control circuit 102 is a wired connection. Wireless connections may also be utilized. It is similarly desirable to connect the drain valve actuator/motor 26 with the storm drain valve 24 via a wired connection, although a wireless connection could similarly be used.

In some embodiments, power is provided via a rechargeable battery 30 connected with a solar panel 32 that is configured for charging the battery 30.

As discussed in more detail below, the control circuit 102 is programmed to selectively open and close the storm drain valve 24 by activating the drain valve actuator/motor 26 based on at least one of a communication from the property manager and the digital weather code.

The system 10 does not depend on analysis by private entities, but rather references a very stable and free platform —The National Weather Service. The control center 100, 102 is located onsite and will trigger the system to open the storm drain valve 24 based on a flood warning or other suitable weather event/code, or can be managed wholly by the owner/operator via a computer or smartphone (by way of the world-wide web through the cellular network communication device 18). The system uses inexpensive cellphone data at the control center 100, 102 to send information to a website, where information regarding the status of the system is received. That information is organized in a manner that the storm drain valve 24 can be controlled and monitored.

The weather receiver 14 may consist of a 162 MHz, 7 Channel NOAA Weather Receiver along with a SAME (Specific Area Message Encoding) decoder 16. The decoder 16 digitally decodes all National Weather Service Advisories, Watches, Warnings and Tests and also digitally decodes FIPS State Code and County Code.

In use, each remote system 10 is fully configurable to limit responses to only messages for specific FIPS State Code(s) and County Code(s). In some embodiments, each remote system 10 is configurable for one of four responses per Advisory, Watch, Warning and Test for configured FIPS State Code(s) and County Code(s):

1. Take No Action

2. Notify Manager

3. Notify Manager AND Open apparatus

4. Notify Manager AND Close apparatus.

In the event that the system 10 opens the storm drain valve 24 automatically, it is typically opened for a preset time, depending on many factors including a size of the pond. Subsequently, the system 10 automatically closes the storm drain valve 24.

A Low or No signal strength from the weather receiver 14 at any networked remote system can send an alert to the manager. Additionally, in the event that the storm drain valve 24 is neither fully open nor fully closed (possible stuck valve), the system 10 can alert the manager. The system 10 also broadcasts to the manager the weather receiver 14 signal strength and apparatus status for each networked remote system. The manager can remotely change the weather receiver channel for each networked remote system. Each networked remote system can be assigned a name to make notifications and alerts easily and quickly understood.

A typical configuration could be to notify the manager when a Flood Advisory or Watch is issued via the NOAA weather receiver/decoder 14, 16 with the configured FIPS State Code(s) and County Code(s) at one of the networked remote systems 10 including the assigned name of the networked remote system that received the Flood Advisory or Watch but take no other action. If, however, the message is a Flood Warning, the system can notify the manager and automatically open the storm drain valve 24. Subsequently, after the preset amount of time, the system 10 can automatically close the storm drain valve 24.

The system 10 could also be configured to notify the manager when the NOAA weekly test is performed but take no other action. There will be a separate notification for each remote system in the network. This will indicate that the system is fully functional and ready to respond in case of a flood. In the unlikely event that a weekly test notification does not arrive when expected, that specific remote system can checked for errors.

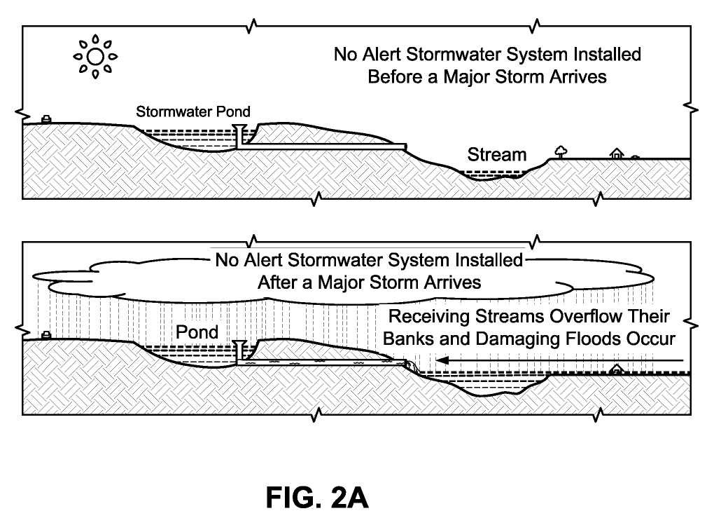

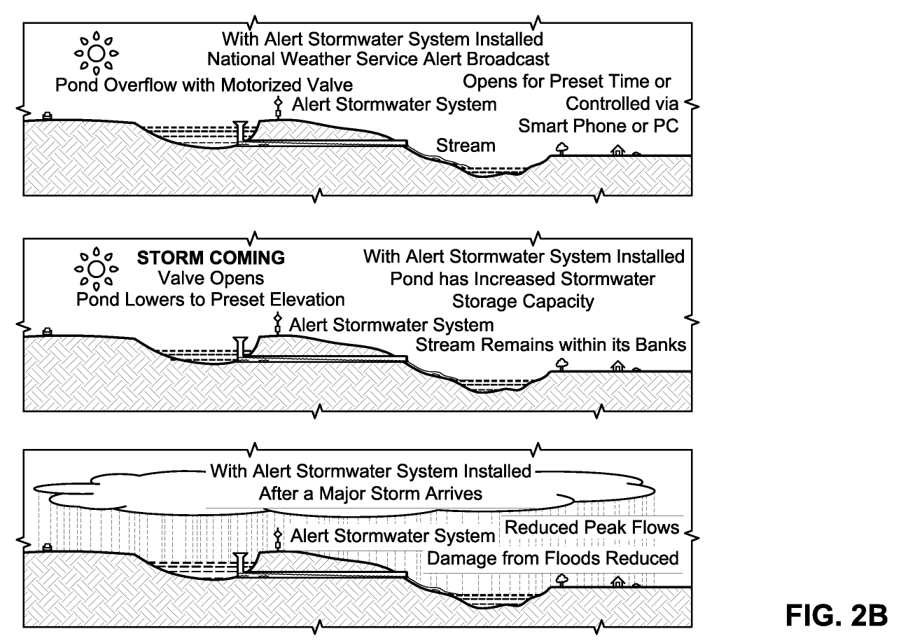

FIG. 2A is a graphical representation showing a need for the remote pond volume adjustment system of the described embodiments. As shown, without the system, a pond can overflow in the event of heavy rains or the like, causing receiving streams to overflow their banks, resulting in damaging floods. With the system of the described embodiments, with reference to FIG. 2B, upon receipt of a National Weather Service alert broadcast, the storm drain valve can be opened prior to the storm to increase storm water storage capacity of the pond. As a result, the pond can better accommodate peak flows and prevent the receiving streams from overflowing.

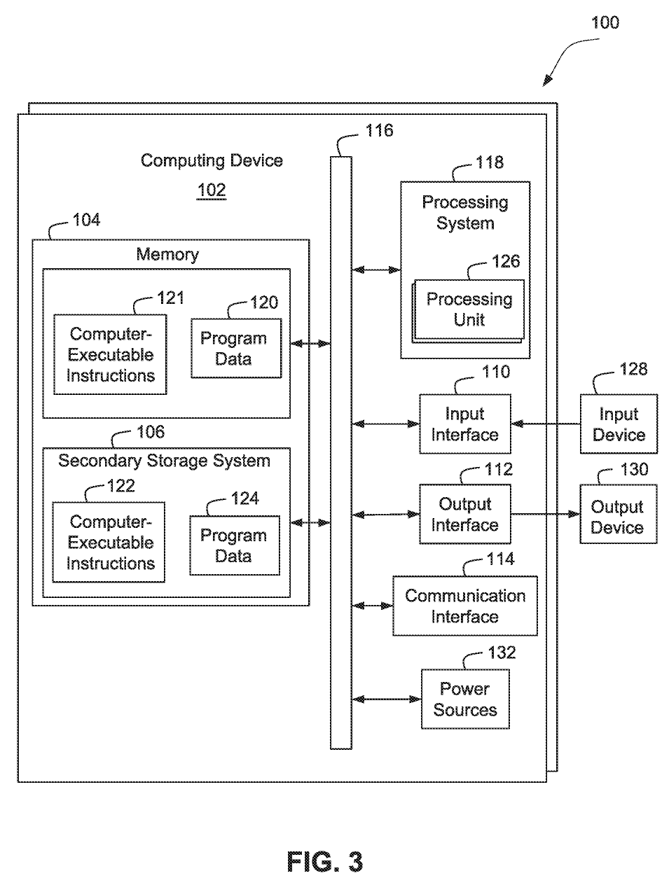

In some applications, the stormwater management system is administered using a computer system. Any known computer configuration capable of carrying out the intended functionality of the preferred embodiments may be used. FIG. 3 is a block diagram of an example configuration of a computer system 100 in which the techniques of this disclosure may be implemented. In the example of FIG. 3, computer system 100 comprises a computing device or control circuit 102 and one or more other computing devices. Computer system 100 or similar computing systems implement the stormwater system. Computing device 102 is an electronic device that processes information. In the example of FIG. 3, computing device 102 comprises a data storage system 104, a memory 108, a secondary storage system 106, a processing system 118, an input interface 110, an output interface 112, a communication interface 114, one or more power sources 132, and one or more communication media 116. Communication media 116 enable data communication between processing system 118, input interface 110, output interface 112, communication interface 114, memory 108, and secondary storage system 106. Computing device 102 can include components in addition to those shown in the example of FIG. 3. Furthermore, some computing devices do not include all of the components shown in the example of FIG. 3. Each of components 104, 106, 108, 110, 112, 114, 116, 118, 120, 121, 122, 124, 126, 128, 130, and 132 can be interconnected (physically, communicatively, or operatively) for inter-component communications.

Data storage system 104 is a system that stores data for subsequent retrieval. In the example of FIG. 3, data storage system 104 comprises memory 108 and secondary storage system 106. Memory 108 and secondary storage system 106 store data for later retrieval. In the example of FIG. 3, memory 108 stores computer-executable instructions 121 and program data 120. Secondary storage system 106 stores computer-executable instructions 122 and program data 124. Physically, memory 108 and secondary storage system 106 each comprise one or more computer-readable storage media.

A computer-readable medium is a medium from which a processing system can read data. Computer-readable media include computer storage media and communications media. Computer storage media can further include physical devices that store data for subsequent retrieval. Computer storage media are not transitory. For instance, computer storage media do not exclusively comprise propagated signals. Computer storage media include volatile storage media and non-volatile storage media. Example types of computer storage media include random-access memory (RAM) units, read-only memory (ROM) devices, solid state memory devices, optical discs (e.g., compact discs, DVDs, BluRay discs, etc.), magnetic disk drives, electrically-erasable programmable read-only memory (EEPROM), programmable read-only memory (PROM), magnetic tape drives, magnetic disks, and other types of devices that store data for subsequent retrieval. Communication media includes media over which one device can communicate data to another device. Example types of communication media include communication networks, communications cables, wireless communication links, communication buses, and other media over which one device is able to communicate data to another device.

Referring again to FIG. 3, processing system 118 is coupled to data storage system 104. Processing system 118 reads computer-executable instructions (e.g., 121, 122) from data storage system 104 and executes the computer-executable instructions. Execution of the computer-executable instructions by processing system 118 configures and/or causes computing device 102 to perform the actions indicated by the computer-executable instructions. For example, execution of the computer-executable instructions by processing system 108 can configure and/or cause computing device 102 to provide Basic Input/Output Systems (BIOS), operating systems, system programs, application programs, or can configure and/or cause computing device 102 to provide other functionality.

Processing system 118 reads the computer-executable instructions from one or more computer-readable media. For example, processing system 118 reads and executes computer-executable instructions 121 and 122 stored on memory 108 and secondary storage system 106.

Processing system 118 comprises one or more processing units 126. Processing units 126 comprise physical devices that execute computer-executable instructions. Processing system 118 can also include one or more operating systems that are executable by computing device 102. Processing units 126 comprise various types of physical devices that execute computer-executable instructions. For example, one or more of processing units 126 comprise a microprocessor, a processing core within a microprocessor, a digital signal processor, a graphics processing unit, or another type of physical device that executes computer-executable instructions.

Input interface 110 enables computing device 102 to receive input from an input device 128. Input device 128 comprises a device that receives input from a user. Input device 128 comprises one or more various types of devices that receive input from users. For example, input device 128 comprises a keyboard, a touch screen, a mouse, a microphone, a keypad, a joystick, a brain-computer interface device, or another type of device that receives input from a user. In some examples, input device 128 is integrated into a housing of computing device 102. In other examples, input device 128 is outside a housing of computing device 102.

Output interface 112 enables computing device 102 to output information on one or more output devices 130. One or more output devices 130, in some examples, are configured to provide output to a user using tactile, audio, or video output. For example, an output device 130 is a device that displays output. Example types of display devices include monitors, touch screens, display screens, televisions, and other types of devices that display output. In some examples, output device 130 is integrated into a housing of computing device 102. In other examples, output device 130 is outside a housing of computing device 102. Output devices 130, in one example, includes a presence-sensitive screen or a touch screen. Output devices 130 can utilize a sound card, a video graphics adapter card, or any other type of device for converting a signal into an appropriate form understandable to humans or machines. Additional examples of output device 130 include a speaker, a cathode ray tube (CRT) monitor, a liquid crystal display (LCD), or any other type of device that can generate intelligible output to a user.

Communication interface 114 enables computing device 102 to send and receive data over one or more communication media. In some examples, computing device 102 utilizes one or more communication interfaces 114 to wirelessly communicate with an external device such as server device or a client device, a mobile phone, or other networked computing device. Communication interface 114 comprises various types of devices. For example, communication interface 114 comprises a Network Interface Card (NIC), a wireless network adapter, a Universal Serial Bus (USB) port, or another type of device that enables computing device 102 to send and receive data over one or more communication media. In some examples, communications interface 114 comprises a network interface to communicate with external devices via one or more networks, such as one or more wireless networks. Examples of communications interface 114 are an Ethernet card, an optical transceiver, a radio frequency transceiver, or any other type of device that can send and receive information. Other examples of such network interfaces include Bluetooth®, cellular (e.g., 3G, 4G, 5G) and Wi-Fi® radios in mobile computing devices. In some examples, communication interface 114 receives configuration data, trial data, and/or other types of data as described above. Furthermore, in some examples, communication interface 114 outputs information and/or other types of data as described above.

Computing device 102, in some examples, includes one or more power sources 132, which may be rechargeable and provide power to computing device 102. In some examples, the one or more power sources 132 are one or more batteries. The one or more batteries could be made from nickel-cadmium, lithium-ion, or any other suitable material. In another example, the one or more power sources 132 include a power supply connection that receives power from a power source external to computing device 102.

The techniques described herein may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described herein. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described herein may also be embodied or encoded in a computer-readable medium, such as a computer-readable storage medium, containing instructions. Instructions embedded or encoded in a computer-readable medium, including a computer-readable storage medium, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A remote pond volume adjustment system comprising:
a control circuit;
a weather receiver configured to receive a public broadcast from the National Weather Service;
a weather receiver decoder connected with the weather receiver and the control circuit, the weather receiver decoder being configured to digitize the public broadcast and output a digital weather code; and
a cellular network communication device connected with the control circuit, the cellular network communication device being configured to communicate with a property manager,
wherein the control circuit is programmed to selectively open and close a drain valve based on at least one of a communication from the property manager and the digital weather code.

2. A remote pond volume adjustment system according to claim 1, further comprising a drain valve actuator connected with the drain valve and the control circuit, the drain valve actuator being configured to drive the drain valve between a closed position and an open position.

3. A remote pond volume adjustment system according to claim 2, wherein the drain valve actuator is connected with the drain valve via a wired connection.

4. A remote pond volume adjustment system according to claim 1, further comprising a battery for powering the system.

5. A remote pond volume adjustment system according to claim 4, wherein the battery is rechargeable, the system further comprising a solar panel connected with the battery and configured to charge the battery.

6. A remote pond volume adjustment system according to claim 1, wherein the cellular network communication device comprises a cellular antenna.

7. A remote pond volume adjustment system according to claim 1, wherein the cellular network communication device comprises a cellular modem.

8. A remote pond volume adjustment system according to claim 1, wherein the drain valve comprises a sluice gate.

9. A method of remotely adjusting pond volume, the method comprising:
(a) receiving with a weather receiver a public broadcast from the National Weather Service;
(b) digitizing with a weather receiver decoder the public broadcast and outputting a digital weather code;
(c) providing a cellular network communication device configured to communicate with a property manager; and
(d) selectively opening and closing a drain valve based on at least one of a communication from the property manager and the digital weather code.

10. A method according to claim 9, wherein step (d) is practiced by opening the drain valve without input from the property manager if the digital weather code is one of several predefined digital weather codes.

11. A method according to claim 10, wherein step (d) is further practiced by automatically closing the drain valve after a predetermined time.

12. A method according to claim 9, further comprising providing a drain valve actuator connected with the drain valve, wherein step (d) is practiced by driving the drain valve between a closed position and an open position.

13. A remote pond volume adjustment system for adjusting a water volume in a pond, the pond including primary drain valve connected to an overflow reservoir, the remote pond volume adjustment system comprising:
a housing positioned in a vicinity of the pond;
a circuit board mounted in the housing and defining a control circuit;
a weather receiver mounted in the housing and configured to receive a public broadcast from the National Weather Service;
a weather receiver decoder mounted in the housing and connected with the weather receiver and the control circuit, the weather receiver decoder being configured to digitize the public broadcast and output a digital weather code;
a cellular network communication device at least partially mounted in the housing and connected with the control circuit, the cellular network communication device being configured to communicate with a property manager;
a storm drain valve connected to the overflow reservoir; and
a drain valve actuator connected with the storm drain valve and the control circuit, the drain valve actuator being configured to drive the storm drain valve between a closed position and an open position,
wherein the control circuit is programmed to selectively open and close the storm drain valve by activating the drain valve actuator based on at least one of a communication from the property manager and the digital weather code.

14. A remote pond volume adjustment system according to claim 13, wherein the storm drain valve is positioned vertically higher in the pond than the primary drain valve.

15. A remote pond volume adjustment system according to claim 13, wherein the drain valve actuator is connected with the control circuit via a wired connection.

16. A remote pond volume adjustment system according to claim 13, further comprising a battery for powering the system.

17. A remote pond volume adjustment system according to claim 16, wherein the battery is rechargeable, the system further comprising a solar panel connected with the battery and configured to charge the battery.

18. A remote pond volume adjustment system according to claim 13, wherein the drain valve comprises a sluice gate.
